(19) United States
(12) Patent Application Publication
(10) Pub. No.: US 2006/0024838 A1
(43) Pub. Date: Feb. 2, 2006

(54) METHOD AND APPARATUS FOR PRESERVING URINE SPECIMENS AT ROOM TEMPERATURE

(75) Inventor: Donald H. Leaman JR., Phoenix, AZ (US)

Correspondence Address: SNELL & WILMER;ONE ARIZONA CENTER, 400 EAST VAN BUREN, PHOENIX, AZ, 850040001, US

(73) Assignee: STOCKWELL SCIENTIFIC, INC., Scottsdale, AZ (US)

(21) Appl. No.: 11/162,320

(22) Filed: Sep. 6, 2005

Related U.S. Application Data
(63) Continuation of application No. 10/335,456, filed on Dec. 31, 2002, now abandoned.

(51) Int. Cl. G01N 1/00

(52) U.S. Cl. 436/176

(57) ABSTRACT

A method and apparatus for preserving urine specimens at room temperature for testing includes a container which is made of a plastic and an antimicrobial where the plastic and antimicrobial form a uniform composition throughout the entire mass of the container by simultaneously injection molding the plastic and antimicrobial to form the container. The container preferably has a test tube shape with triclosan as the preferable antimicrobial.

### CROSS-REFERENCE TO RELATED APPLICATIONS

This application is a continuation of U.S. Ser. No. 10/335,456 entitled “Method and Apparatus for Preserving Urine Specimens at Room Temperature” filed on Dec. 31, 2002, and which application is hereby incorporated by reference.

### FIELD OF INVENTION

The present invention generally relates to a method and apparatus for preserving urine specimens for testing that are transported and/or stored at room temperature, and more particularly relates to a method and apparatus for maintaining stabilization of a urine specimen at room temperature which includes a container comprising a uniform composition of a plastic and an antimicrobial throughout its mass and surface area. Once a urine sample is placed in the container, the contact of the urine with the tube produces an environment which, depending on the concentration of the additive, 1) prevents bacterial and fungal growth at room temperature while maintaining the composition and specific gravity of the urine sample for chemical testing and microscopic examination, and 2) partially inhibits the growth of bacteria and fungi in the specimen so that when the specimen is removed from the inhibitory environment and cultured appropriately it can be identified for diagnostic/therapeutic purposes.

### BACKGROUND OF INVENTION

Antimicrobial devices for use with urine drainage bags in order to prevent infectious organisms from entering the bag are well known in the art. Urine drainage bags are connected to a catheter which is inserted into a patient's urinary tract and, since the urinary tract is a common site for patient infection, the purpose of such antimicrobial devices is to prevent urine that is contaminated with infectious material from entering the patient's urinary tract. Examples of such devices can be seen in U.S. Pat. No. 4,723,950, issued to Lee, and U.S. Pat. No. 5,176,665 issued to Watanabe et al. These patents describe tubular shaped devices that can be made by compounding and co-extruding a polymer and a biocide or microbicidal agent to form the tubular device which fits into a port of a urinary collection bag or container. Again, the purpose of these devices is to eliminate pathogens or infectious material in the bag or container.

Other devices which are made by extruding or molding a resin with an antimicrobial agent have been used for a variety of devices. For example, U.S. Pat. No. 4,603,152 issued to Laurin et al. describes an antimicrobial metal compound mixed with a resin that can be directly molded into a device used for medical purposes such as, for example, shunts, cannulae, catheters, catheter adapters, wires and other solid or hollow tubular devices. Again, the purpose of these devices is to inhibit the proliferation of bacteria and the like in order to prevent patient infection.

Triclosan has also been known in the prior art to function as an antimicrobial agent in medical devices and other articles which come in contact with a patient or user. For example, U.S. Pat. No. 5,772,640 issued to Modak et al. describes medical articles which include synergistic combinations of chlorhexidine and triclosan where the medical articles are impregnated or coated with the combination. In addition, U.S. Pat. No. 5,091,442 issued to Milner describes tubular articles used in the medical sciences such as catheters, condoms, wound drains, endotracheal tubes and the like that are made by mixing triclosan with the material that forms the article prior to forming the article. However, the purpose of the invention is to prevent bacteria from growing on the surface of the article and to improve the barrier properties of the article against transmission of bacteria to a patient or a user.

Although the prior described devices include some of the materials which comprise the present invention, they are not directed to solve the same problem of the present invention. The present invention is directed to a container or collection device which functions to stabilize or preserve the characteristics of a urine sample for storing or transporting at room temperature until the sample is tested. Although some devices for collecting and preserving the characteristics of a urine sample are known, such as the device described in U.S. Pat. No. 4,042,337, none of the prior art devices have the advantages afforded by the present invention.

### SUMMARY OF INVENTION

The present invention is directed to a device or container for stabilizing or preserving a urine specimen at room temperature for later testing without changing the composition of the urine. The device or container is comprised of a plastic and an antimicrobial which are combined and injection molded to form the container.

A preferred embodiment of the invention includes a plastic in an amount of around 99.5 to 99.92% by weight of the container and an antimicrobial in an amount of about 0.08 to 0.50% by weight of the container. An embodiment of the container which produced particularly good results was a test tube shaped container made of polypropylene copolymer and triclosan formed within the above described ranges.

The method for making the device or container of the present invention preferably includes the steps of selecting a plastic material, selecting an antimicrobial material, and blending the antimicrobial material into the plastic material during or before injection molding to form the container. In one embodiment (urine transport for urinalysis or culture), the mixture is preferably formed into the shape of a test tube with a plug or screw cap. In further applications the mixture is preferably formed into the shape of a screw cap tube, specimen cup, flat faced cuvette or bottle.

A principal object of the present invention is to provide an environment for storing and/or transporting a urine specimen at room temperature which prevents or limits the growth of microbes that are intrinsic to the urine specimen and which would otherwise grow at room temperature and which would consume or alter the markers of disease or controlled substances or their metabolites that are present in the urine. In the case of the urine culture application, the microorganisms are inhibited, but kept viable so that they can later be cultured and identified. The present invention performs this preservative function without adding solutes to the urine specimen which could alter its specific gravity, without adding buffers or acidifying agents which could alter the specimen's pH level, and without contaminating the specimen with undissolved crystals or solids which could interfere with the microscopic analysis of the urine specimen. All of these constitute advantages over prior art containers for collecting and preserving urine samples.

The present invention also performs its preservative function without the need for adding proteins or nitrites to the urine specimen thereby avoiding false positive protein readings and nitrite results, respectively, on standard urine dipstick tests. Another advantage of the device of the present invention over the prior art is its ability to perform its preservative function without the need to handle and add mercury containing tablets to the urine specimen thereby preventing any accidental ingestion and poisoning with mercury containing antimicrobials. Still another advantage of the present invention is the flexibility in sample size that can be used with the present invention. Since the antimicrobial is contained throughout the mass of the container, there will be almost a direct exposure rate of urine to container surface area for a small sample amount thereby enabling effective antimicrobial activity for even small sample amounts. The present invention also protects intact cells contained in the urine specimen such as, for example, white blood cells, red blood cells, epithelial cells, kidney casts, and the like, from being degraded by micro-organisms.

### BRIEF DESCRIPTION OF THE DRAWINGS

FIG. 1 shows the growth of E. coli found in urine samples of one individual stored in various embodiments of the urine transport and storage tube of the present invention;

FIG. 2 shows the growth of Candida albicans found in urine samples of one individual stored in various embodiments of the urine transport and storage tube of the present invention;

FIG. 3 shows the growth of Enterobacter cloacae found in urine samples of one individual stored in various embodiments of the urine transport and storage tube of the present invention;

FIG. 4 shows the growth of Enterobacter faecalis found in urine samples of multiple individuals stored in various embodiments of the urine transport and storage tube of the present invention;

FIG. 5 shows the growth of Escherichia coli found in urine samples of multiple individuals stored in various embodiments of the urine transport and storage tube of the present invention;

FIG. 6 show the growth of Klebsiella oxytoca found in urine samples of multiple individuals stored in various embodiments of the urine transport and storage tube of the present invention;

FIG. 7 shows the growth of Klebsiella pneumoniae found in urine samples of multiple individuals stored in various embodiments of the urine transport and storage tube of the present invention;

FIG. 8 shows the growth of Proteus mirabilis found in urine samples of multiple individuals stored in various embodiments of the urine transport and storage tube of the present invention;

FIG. 9 shows the growth of Pseudomonas aeruginosa found in urine samples of multiple individuals stored in various embodiments of the urine transport and storage tube of the present invention;

FIG. 10 shows the growth of Staphylococcus aureus found in urine samples of multiple individuals stored in various embodiments of the urine transport and storage tube of the present invention;

FIG. 11 shows the growth of Candida albicans found in urine samples of multiple individuals stored in various embodiments of the urine transport and storage tube of the present invention; and

FIG. 12 shows the growth of Candida glabrata found in urine samples of multiple individuals stored in various embodiments of the urine transport and storage tube of the present invention.

### DETAILED DESCRIPTION

Preferred exemplary embodiments of the present invention will hereafter be described in conjunction with the description that follows. It will be understood that the detail provided herein is for illustration purposes only and that the subject invention is not so limited.

Urine specimens are routinely collected to diagnose medical conditions and urinary tract infections. When urine specimens cannot be tested or cultured within a two hour time frame from collection of the specimen, use of preservative tablets or powders, or refrigeration is undertaken to preserve the specimen. The two primary devices of the present invention preserve a urine sample for up to 72 hours without restrictions, inconvenience, and the potential hazards of manual additives for urinalysis, and for 72 hours at room temperature for culture and identification.

While specific compositions of the device or container of the present invention will be described in greater detail hereinbelow, in general, the device of the present invention comprises a plastic and an antimicrobial which are blended together and injection molded to form a device or container for stabilizing or preserving a urine sample at room temperature. One preferred exemplary embodiment of the device for urine transport for later urinalysis comprises a polypropylene copolymer and triclosan with the triclosan being in an amount of about 0.08 to 0.50 weight % of the device.

Incorporating the antimicrobial into the structure of the container prevents the deterioration of commonly measured elements and markers of disease in urine specimens for up to 72 hours at temperatures which range from about 4 degrees C. to about 25 degrees C. This range includes room temperature. The diagnostic markers that are preserved by using the present invention to store and/or transport a urine sample include glucose, bilirubin, ketones, specific gravity, blood, pH, protein, urobilinogen, nitrites and leucocytes. Other elements commonly measured in urine samples that are also preserved as a result of using the present invention for storing and/or transporting urine samples include, but are not limited to, microscopically identifiable white blood cells, red blood cells, kidney casts, uric acid crystals, epithelial cells, yeast cells, and ova of certain urinary tract parasites.

A second embodiment of the same invention for urine transport for culture comprises a polypropylene copolymer and triclosan in an amount of about 0.08 to 0.30 weight % of the device. This embodiment may be formed as a pre-mix 10% concentrate of triclosan on polymer beads which is subsequently diluted to the desired concentration in the final product by adjusting the amount of concentrate added. This second embodiment of the invention preserves the viability of bacteria in the urine specimen while preventing overgrowth and subsequent loss of the colony forming units.

The device of the present invention preferably has the form of a test tube and is made by 1) adding a plastic material in raw form, such as plastic pellets, into a hopper which feeds material into an injection molding machine, 2) adding a preservative additive into a separate hopper which also feeds into the injection molding machine, 3) liquefying and mixing the plastic and preservative together inside a heated barrel contained in the injection molding machine, 4) injecting the composition under high pressure into the mold, 5) cooling the composition to solidify it inside the mold, and 6) ejecting the solidified container (preferably test tube) from the mold. Both hoppers are capable of regulating the amount of material that is added as they feed the materials into the injection molding machine.

The present invention is directed to containers for storing and/or transporting a urine specimen at room temperature which limits the growth of microbes that are intrinsic to the urine specimen and which would otherwise grow at room temperature and would exhaust the nutrients in the urine and die out before a culture and identification could be performed. By exerting a bacteriostatic effect on the organisms common to urine samples, the present invention maintains their viability for culture and identification.

Example compositions were formed into test tubes to create the device of the present invention. In one set of exemplary embodiments, urine collection tubes were formed from polystyrene and varying amounts of triclosan known as Microban ingredient B manufactured by Ciba Pharmaceuticals. The 0.2% Tube comprises polystyrene and about 0.2% by weight of triclosan, the 0.5% Tube comprises polystyrene and about 0.5% by weight of triclosan, and the 0.8% Tube comprises polystyrene and about 0.8% by weight of triclosan. Untreated polystyrene “control” tubes were compared with the tubes containing the 3 different levels of triclosan. The tubes were tested with mixed female/male normal urine every 24 hours for a 3 day period at room temperature with the following results:

TABLE 1
Markers/Elements Tested (test data set April 5-8, 2002):

| | Control Day 1 | Control Day 3 |
|---|---|---|
| Urobilinogen | normal (1) | normal (1) |
| Glucose | negative | negative |
| Ketone | negative | negative |
| Bilirubin | negative | negative |
| Protein | negative | trace |
| Nitrite | negative | ++++ |
| Leucocytes | negative | negative |
| Blood (hemolysed) | ++ | + |
| pH | 5 | 5/6 |
| Spec. Gravity | 1.020 | 1.020 |
| Micr. Examination | intact RBC-+++ | intact RBC |
| | intact WBC+++ | less intact WBC |
| | no casts | no casts |
| | squamous+ | squamous+ |
| | uric crystals− | uric crystals− |

| | Day 1 | | | Day 2 | | | Day 3 | | |
|---|---|---|---|---|---|---|---|---|---|
| | 0.2% | 0.5% | 0.8% | 0.2% | 0.5% | 0.8% | 0.2% | 0.5% | 0.8% |
| Urobilinogen | all normal (−) | | | all normal (−) | | | all normal (−) | | |
| Glucose | neg | neg | neg | neg | neg | neg | neg | neg | neg |
| Ketone | neg | neg | neg | neg | neg | neg | neg | neg | neg |
| Bilirubin | neg | neg | neg | neg | neg | neg | neg | neg | neg |
| Protein | neg | neg | neg | neg/tr | neg | neg | neg/tr | neg | neg |
| Nitrite | neg | neg | neg | neg | neg | neg | ++ | + | + |
| Leucocytes | neg | neg | neg | neg | neg | neg | neg | neg | neg |
| Blood (hemolysed) | ++ | ++ | ++ | ++ | ++ | ++ | + | ++ | ++ |
| pH | 5 | 5 | 5 | 5 | 5 | 5 | 5/6 | 5 | 5 |
| Spec. Gravity | 1.020″ | 1.020″ | 1.020″ | 1.020″ | 1.020″ | 1.020″ | 1.020″ | 1.020″ | 1.020″ |
| Micr. Examination | all intact RBC | | | all intact RBC | | | all intact RBC | | |
| | all intact WBC | | | all intact WBC | | | all intact WBC | | |
| | TNTC | no | no | no | no | no | no | no | no |
| | | casts | casts | casts | casts | casts | casts | casts | casts |

+ small
++ medium
+++ large

The urine in the test tubes was tested with DiaScreen 10 test strips manufactured by MEDgenesis. Results show that the test tubes of the present invention comprising polystyrene and either 0.5% or 0.8% by weight triclosan performed best in preserving urine composition at room temperature for urinalysis and the 0.2% was best for urine culture.

Tests were also performed on example compositions formed into test tubes comprising polypropylene and varying amounts of triclosan known as Microban ingredient B manufactured by Ciba Pharmaceuticals. The 0.08% Tube comprises polypropylene and about 0.08% by weight of triclosan, the 0.12% Tube comprises polypropylene and about 0.12% by weight of triclosan. Because of the easier migration of the triclosan to the surface of the plastic in polypropylene versus polystyrene, lower concentrations were tried. Like the polystyrene containing tubes described above, these exemplary tubes were also tested with mixed female/male normal urine every 24 hours for a 3 day period at room temperature. Untreated polypropylene “control” tubes were compared with two different levels of triclosan and polypropylene tubes (0.08% and 0.12%) and 0.5% triclosan in polystyrene. Additionally, two commercially available products for urinalysis transport (Becton Dickinson tubes and Cargille Stabilur tablet tubes) were also tested. Like the polystyrene containing tubes described above, these exemplary tubes, controls and commercially available products were also tested with mixed female/male normal urine every 24 hours for a 3 day period at room temperature. Results from the testing were as follows:

TABLE 2
(data set of May 3-5, 2002)
Multistix 10SG Dipsticks

| | FS 0 | FS 1 | FS 2 | FS 3 | Stb 1 | Stb 2 | Stb 3 |
|---|---|---|---|---|---|---|---|
| | Fresh | Fresh | Fresh | Fresh | Stabilur | Stabilur | Stabilur |
| | Sample | 24 Hrs. | 48 Hrs. | 72 Hrs. | 24 Hrs. | 48 Hrs. | 72 Hrs. |
| Urobilinogen | normal | normal | normal | normal | normal | normal | normal |
| Glucose | 250 | 100/250 | negative | negative | 100 | 100 | 100 |
| Ketone | negative | negative | negative | negative | negative | negative | negative |
| Bilirubin | negative | negative | negative | negative | negative | negative | negative |
| Protein | trace | trace | trace | trace/- | trace | trace | trace |
| Nitrite | negative | negative | negative | negative | +++ | +++ | +++ |
| Leucocytes | negative | negative | negative | negative | negative | negative | negative |
| Blood | mod NH | negative | negative | negative | negative | negative | mod N |
| pH | 6 | 6 | 6 | 7 | 6 | 6 | 6.5 |
| Spec. Gravity | 1.030″ | 1.030″ | 1.030″ | 1.025″ | 1.030″ | 1.030″ | 1.030″ |
| Visual Examination | | | | | | | |
| clarity | clear | | | | | | |
| color | straw | | | | | | |
| Micr. Examination | | | | | | | |
| WBC | +++ | +++ | + | + | +++ | ++ | ++ |
| RBC | +++ | +++ | + | + | +++ | ++ | ++ |
| epithelial | + | + | + | + | + | + | + |
| bacteria | negative | ++ | +++ | +++ | negative | negative | + |
| crystals | negative | negative | negative | negative | negative | negative | negative |
| Bacterial Action | | | | | | | |
| nitrite, ppm | negative | negative | negative | negative | 10.0++ | 10.0++ | 10.0++ |
| ammonia, ppm | negative | 1 | 6.0+ | 6.0+ | negative | 1 | 3 |
| | BD 0 | BD 1 | BD 2 | BD 3 | PP 8 1 | PP 8 2 | PP 8 3 |
| | BDtube | BDtube | BDtube | BDtube | PP .08% | PP .08% | PP .08% |
| | Day 0 | 24 Hrs. | 48 Hrs. | 72 Hrs. | 24 Hrs. | 48 Hrs. | 72 Hrs. |
| Urobilinogen | normal | normal | normal | normal | normal | normal | normal |
| Glucose | 100 | 100 | 100 | 100 | 100 | 100 | 100 |
| Ketone | negative | negative | negative | negative | negative | negative | negative |
| Bilirubin | negative | negative | negative | negative | negative | negative | negative |
| Protein | trace | trace | trace | trace | trace | trace | trace |
| Nitrite | negative | negative | negative | negative | negative | negative | negative |
| Leucocytes | negative | negative | negative | negative | negative | negative | negative |
| Blood | mod N | negative | negative | negative | negative | negative | negative |
| pH | 6 | 6 | 6 | 6 | 6 | 6 | 6 |
| Spec. Gravity | 1.030″ | 1.030″ | 1.030″ | 1.030″ | 1.030″ | 1.030″ | 1.030″ |
| Micr. Examination | | | | | | | |
| WBC | +++ | ++ | ++ | ++ | +++ | +++ | +++ |
| RBC | ++ | ++ | ++ | ++ | ++ | ++ | ++ |
| epithelial | + | + | + | + | + | + | + |
| bacteria | negative | negative | negative | negative | negative | negative | negative |
| crystals | negative | negative | negative | negative | negative | negative | negative |
| Bacterial Action | | | | | | | |
| nitrite, ppm | negative | negative | negative | negative | negative | negative | negative |
| ammonia, ppm | 1 | 1 | 3 | 6+ | negative | 0.5 | 1 |
| | PP 12 1 | PP 12 2 | PP 12 3 | Styrene1 | Styrene2 | Styrene3 | |
| | PP 0.12 | PP 0.12 | PP 0.12 | PS .5% | PS .5% | PS .5% | |

| | 24 Hrs. | 48 Hrs. | 72 Hrs. | 24 Hrs. | 48 Hrs. | 72 Hrs. |
|---|---|---|---|---|---|---|
| Urobilinogen | normal | normal | normal | normal | normal | normal |
| Glucose | 100/250 | 100/250 | 100/250 | 250 | 250 | 250 |
| Ketone | negative | negative | negative | negative | negative | negative |
| Bilirubin | negative | negative | negative | negative | negative | negative |
| Protein | trace | trace | trace | trace | trace | trace |
| Nitrite | negative | negative | negative | negative | negative | negative |
| Leucocytes | negative | negative | negative | negative | negative | negative |
| Blood | mod N | negative | negative | negative | negative | negative |
| pH | 6 | 6 | 6 | 6 | 6 | 6.5 |
| Spec. Gravity | 1.030″ | 1.030″ | 1.030″ | 1.030″ | 1.030″ | 1.02″ |
| Micr. Examination | | | | | | |
| WBC | +++ | ++ | + | +++ | ++ | ++ |
| RBC | ++ | ++ | ++ | ++ | ++ | ++ |
| epithelial | negative | negative | + | negative | + | + |
| bacteria | negative | ++ | +++ | +++ | negative | negative |
| crystals | negative | negative | negative | negative | negative | negative |
| Bacterial Action | | | | | | |
| nitrite, ppm | negative | negative | negative | negative | negative | negative |
| ammonia, ppm | 0.25 | 0.25 | 0.5+ | 0.25 | 0.5 | 1 |

+ small
++ medium
+++ large

Results show that an optimal weight % of triclosan when combined with polypropylene likely resides between at or above 0.12% for culture applications and above 0.12% for urinalysis applications. Two commercially available tubes (Becton Dickinson Vacutainer R Brand Urine Transport Tube and Urine tubes containing a Cargille Laboratories Stabilur tablet) were tested with the same test urine which contained trace protein, elevated glucose and specific gravity of 1.030. All data matched the Polypropylene 0.12% triclosan tubes except the nitrite reading on the tubes with Stabilur tablets which read +++ (strong false positive) as an artifact of the preservative. Quantitative ammonia tests (not on a standard urinalysis test strip) showed that untreated controls rapidly grew bacteria which measured 6 ppm and blew the caps off the tubes by the 48 hour point. Ammonia tests showed that 0.08 and 0.12% triclosan limited ammonia production to 0.5 ppm and 0.25 ppm, respectively, by 72 hours. Maintenance of the glucose at the borderline 100/250 level by the 0.12% compared to the clear drop to 100 by the 0.08% triclosan tube also indicates better antibacterial performance by 0.12%. Conclusion of this testing on triclosan concentration in polypropylene was that a higher concentration should be tested, i.e. 0.3%.

In another test, polypropylene tubes having 0.30% by weight triclosan were tested. Two commercially available tubes (Becton Dickinson Vacutainer R Brand Urine Transport Tube and Urine tubes containing a Cargille Laboratories Stabilur tablet) were tested with the same test urine which contained heavy contamination of bacteria simulating a urinary tract infection, trace protein, moderate (++) hemolysed blood, very elevated glucose (1000 mg/dl), and specific gravity of 1.030. The results of the testing were as follows:

TABLE 3
(data of June 21-24, 2002)

| | FS 0 | FS 1 | FS 2 | FS 3 | Stb 1 | Stb 2 | Stb 3 |
|---|---|---|---|---|---|---|---|
| | Fresh | Fresh | Fresh | Fresh | Stabilur | Stabilur | Stabilur |
| | Sample | 24 Hrs. | 48 Hrs. | 72 Hrs. | 24 Hrs. | 48 Hrs. | 72 Hrs. |
| Urobilinogen | normal | normal | normal | normal | normal | normal | normal |
| Glucose | 1000 | 1000 | 500 | 500 | 1000 | 1000 | 1000 |
| Ketone | negative | negative | negative | negative | negative | negative | negative |
| Bilirubin | negative | negative | negative | negative | negative | negative | negative |
| Protein | trace | trace | trace | trace | trace | trace | trace |
| Nitrite | +″ | +++″ | +++″ | +++″ | +++ | +++ | +++ |
| Leucocytes | negative | negative | negative | negative | negative | negative | negative |
| Blood | +++″ | ++″ | ++″ | ++″ | +++″ | +++″ | +++″ |
| pH | 6 | 6 | 6 | 6 | 6 | 6 | 6 |
| Spec. Gravity | 1.030″ | 1.030″ | 1.030″ | 1.030″ | 1.030″ | 1.030″ | 1.030″ |
| Visual Examination | | | | | | | |
| clarity | turbid | turbid | turbid | turbid | turbid | turbid | turbid |
| color | yellow | yellow | yellow | yellow | yellow | yellow | yellow |
| Bacterial Action | | | | | | | |
| ammonia, ppm | | | | 6+ | | | 6+ |
| | BD 1 | BD 2 | BD 3 | Stockwell | Stockwell | Stockwell | |
| | BDtube | BDtube | BDtube | PP 0.3%′ | PP 0.3% | PP 0.3% | |

| | 24 Hrs. | 48 Hrs. | 72 Hrs. | 24 Hrs. | 48 Hrs. | 72 Hrs. |
|---|---|---|---|---|---|---|
| Urobilinogen | normal | normal | normal | normal | normal | normal |
| Glucose | 1000 | 1000 | 1000 | 1000 | 1000 | 1000 |
| Ketone | negative | negative | negative | negative | negative | negative |
| Bilirubin | negative | negative | negative | negative | negative | negative |
| Protein | trace | trace | trace | trace | trace | trace |
| Nitrite | negative | negative | negative | ++″ | ++″ | ++″ |
| Leucocytes | negative | negative | negative | negative | negative | negative |
| Blood | ++″ | ++″ | ++″ | +++″ | ++″ | ++″ |
| pH | 6 | 6 | 6 | 6 | 6 | 6 |
| Spec. Gravity | 1.030 | 1.030 | 1.030 | 1.030 | 1.030 | 1.030 |
| Visual. Examination | | | | | | |
| Clarity | turbid | turbid | turbid | turbid | turbid | turbid |
| Color | yellow | yellow | yellow | yellow | yellow | yellow |
| Bacterial Action | | | | | | |
| Ammonium ppm | 6+ | | 6+ | | | |

The 0.3% triclosan containing polypropylene tube produced stabilization up to 72 hours which most closely matched the fresh sample on day 0. The Stabilur tablet tube also matched, but it is documented that the nitrite reading is artifactual, even though it happens to match the fresh sample. The BD tube produced false negative results on nitrite, but matched otherwise.

Leaching experiments were also conducted on the exemplary embodiment comprising an injection molded test tube formed from a mixture of polypropylene and 0.08%, 0.12%, 0.20% and 0.30% triclosan to determine the levels of triclosan which were released from the tube wall into the urine specimen volume during a period of three days. Results were as follows:

TABLE 4
STOCKWELL SCIENTIFIC STUDIES
OF LEACHING OF INGREDIENT B
(Data set from Microban Americas, Jun. 21, 2002)

| Ingredient B | Ingredient B | Day 1 | Day 2 | Day 3 |
|---|---|---|---|---|
| Concentration | Concentration | ppm | ppm | ppm |
| in Polypropylene | in Polypropylene, ppm | Leached | Leached | Leached |
| 0.08% | 800 | 0.222 | 0.242 | 0.284 |
| 0.12% | 1200 | 0.298 | 0.316 | 0.305 |
| 0.20% | 2000 | 0.347 | 0.405 | 0.406 |
| 0.30% | 3000 | 0.497 | 0.563 | 0.542 |

The results of the Leaching Test showed that triclosan, a highly hydrophobic compound which migrates to the surface of the polypropylene, only enters the aqueous contents of the tube at 0.019% of its level in the plastic, i.e. 0.542 ppm after three days compared to 3,000 ppm in the polypropylene tube. This supports the conclusion that the primary mechanism of action of the invention is microbial organism contact with the wall of the tube with a minor secondary mechanism of releasing parts per billion of the triclosan into the urine. The results of the clinical urine sample tests show that the embodiment comprising polypropylene 0.12%-0.3% by weight triclosan to be successful in preserving urine chemistry and composition at room temperature over a three day period.

Additional testing was performed by an independent testing agency which tested transfer tubes having different levels of triclosan as the antimicrobial contained within the tubes. Four levels were tested in a preliminary experiment and included a control level which included tubes having no triclosan, level A which included tubes having 0.08% triclosan, level B which included tubes having 0.12% triclosan, and level C which included tubes having 0.2% triclosan. A final experiment was also conducted which included a control level having no triclosan, a level having 0.2% triclosan, and a level having 0.3% triclosan.

The materials and analytical methods used for the experiments were as follows:

Materials:

Microorganisms (All from the American Type Culture Collection (Manassas, Va.):

Bacterial isolates that will be utilized are: Enterobacter cloacae (ATCC 35549), Enterococcus faecalis (ATCC 49332), Escherichia coli (ATCC 25922), Kliebsiella oxytoca (ATCC 49131), Klebsiella pneumoniae (ATCC 35555), Proteus mirabilis (ATCC), Pseudomonas aeruginosa (ATCC 9027), and Staphylococcus aureus (ATCC 29213).

Yeast isolates to be utilized are: Candida albicans (ATCC 10231) and Candida glabrata (ATCC 2001).

Media:

Tryptic Soy Broth (TSB) (30 g/L dehydrated medium, Difco).

Tryptic Soy Agar (TSA) (40 g/L dehydrated medium, Difco with 1 ml/L 1 N. NaOH).

Blood agar plate (BAP): Tryptic Soy Agar amended w/5% defibrinated sheep blood.

Transport tubes with Levels A, B, or C stabilizer were used in the preliminary experiment (where A is 0.08% stabilizer, B is 0.12% stabilizer and C is 0.2% stabilizer), and without stabilizer (control). In the final experiment, transport tubes were supplied with no stabilizer (control), 0.2% (equivalent to level C) and 0.3% stabilizer.

McFarland Turbidity Standards (VWR, barium chloride in sulfuric acid solutions).

Sterile supplies:

100 and 150 mm disposable Petri dishes.

Conical centrifuge tubes: 50, 16, and 1.5 ml.

200 ml polypropylene bottles for urine collection.

Micropipetters (P-200 and P-20) and sterile tips.

Disposable inoculating loops.

96 well microplates with lids.

500 ml disposable plastic filtration bottles with 0.2 micron filter units.

Deionized water

Butterfield's buffer

Elx808iu Microplate Reader (Bio-Tek Instruments, Inc., Winooski, Vt.).

Microscope and hemocytometer.

Multistix 10 SG (Bayer Corporation, Elkhart, Ind.) for glucose, bilirubin, ketone, specific gravity, blood, pH, protein, urobilinogen, nitrile and leukocytes.

Analytical Methods:

Microwell modification of the Most Probable Number (MPN) technique:

ISO 9308-3: Water Quality—Detection and Enumeration of Escherichia coli and Coliform Bacteria in Surface and Waste Water and

ISO 4831: Microbiology—General Guidance for the Enumeration of Coliforms—Most Probable Number Technique.

(1) Urine was collected from male volunteers and tested via a Multistix 10 SG to insure that the urine was normal prior to use. The urine was filter-sterilized and dispensed immediately into the stabilizer and control (non-stabilizer) transport bottles that had been previously rinsed with sterile distilled water to remove any contaminating organisms.

(2) Each test organism was maintained on BAP at 37° C. For inoculation, a suspension of each organism was prepared by transferring a colony to sterile Butterfield's buffer.

(3) The organisms were adjusted to a turbidity of 0.5 McFarland units, corresponding to approximately 1×10⁷ cells.

(4) The test organisms were then diluted into sterile urine at 1:1000 to yield a final concentration of approximately 1×10⁴ cells/ml of urine in stabilizer (treatment) and non-stabilizer (control) tubes.

(5) Two replicates were conducted for each treatment and control in this preliminary experiment. Three replicates were conducted for each treatment in the final experiment.

(6) The inoculated urine was maintained at room temperature and subsamples removed at 0, 24, 48 and 72 hours.

(7) The MPN method involved a 1:100 dilution in the first microwell, a 1:10 (final 1:1000) from the first to the second microwell and 1:2 serial dilutions thereafter for a total of 12 dilutions in TSB.

(8) The microplates were incubated at 37° C. for 24 hours and growth was visually assessed for turbidity.

The urine used for the preliminary experiment was collected from a single volunteer. It was found to be normal in all of the biochemical tests on the Multistix 10 SG prior to inoculation.

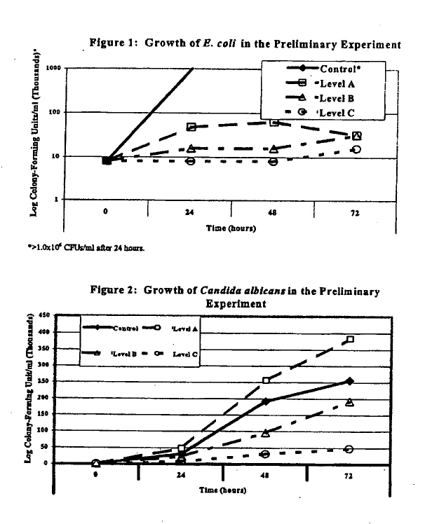

The growth curves for Escherichia coli and Candida albicans are shown in FIGS. 1 and 2, respectively. The data indicates that all three levels of stabilizing additive inhibited growth of E. coli, but only level C appeared to completely or nearly completely inhibit growth (FIG. 1). Level C was also the most efficacious for inhibiting growth of C. albicans, but there appeared to be approximately five generations of growth going from approximately 1000 CFUs/mL C. albicans, initially, to 48,000 CFUs/mL after 72 hours (FIG. 2). The control (no stabilizer) grew to over 500,000 CFUs/mL in the same time period, indicating that there was biostasis of C. albicans. Overall, the preliminary experiment indicated that level C of the stabilizer was the most efficacious of the three levels tested. This serves as the basis for the levels tested in the final experiment of 0.2% stabilizer (equivalent to level C) and 0.3% stabilizer.

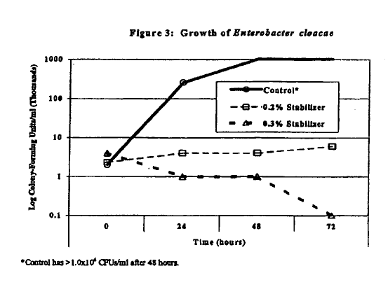

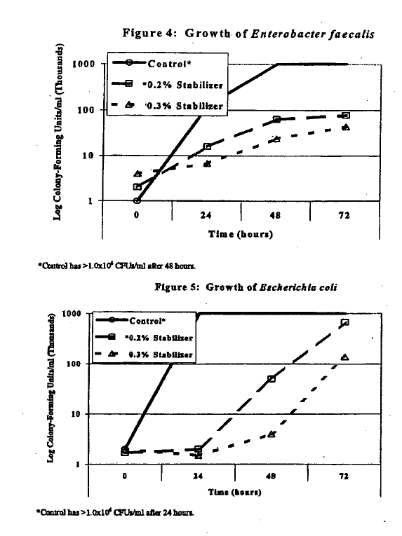

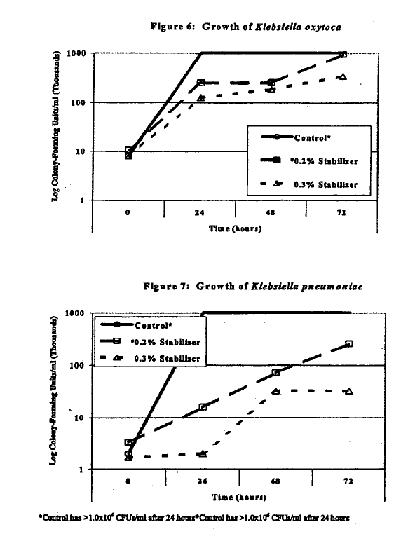

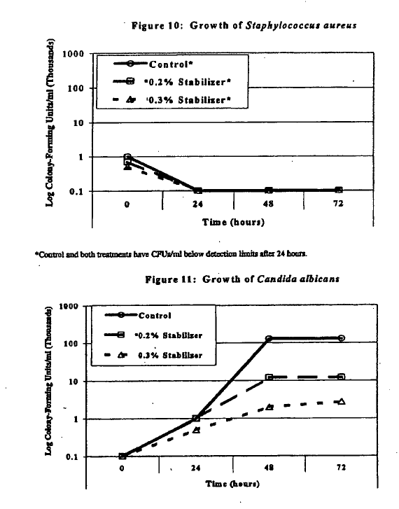

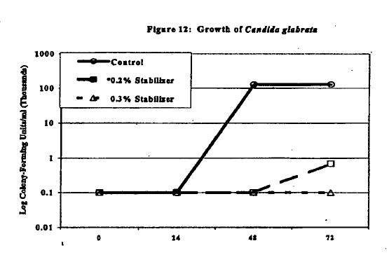

The urine used for the final experiment was collected from nine volunteers. They were all found to be normal in the biochemical tests on the Multistix 10 SG, prior to inoculation. The growth curves for Enterobacter cloacae, Enterococcus faecalis, Escherichia coli, Klebsiella oxytoca, Klebsiella pneumoniae, Proteus mirabilis, Pseudomonas aeruginosa, Staphylococcus aureus, Candida albicans, and Candida glabrata are shown in FIGS. 3 through 12, respectively. The results indicate:

Two organisms showed complete biostasis over the complete 72-hour course of the test, both in tubes with 0.3% stabilizer; Proteus mirabilis, and Candida glabrata. Five organisms, E. faecalis, E. coli, K. oxytoca, K. pneumoniae, and C. albicans all had reduced growth rates in stabilizer-treated tubes.

Two organisms showed possible biocidal activity: Enterobacter cloacae in tubes with 0.3% stabilizer, and Staphylococcus aureus in all tubes including the controls without stabilizer. The volunteers supplying the urine were surveyed to determine if any were taking antibiotics, which could affect the viability of the organisms, particularly S. aureus. None of the volunteers were on antibiotics at the time of the urine collection.

Neither the 0.2% nor 0.3% stabilizer appeared to repress the growth of Pseudomonas aeruginosa.

The apparatus of the present invention was able to achieve partial or total biostasis, as indicated by repressed growth of seven organisms. Complete biostasis was achieved in Proteus mirabilis and Candida glabrata. Biostasis was not achieved with Pseudomonas aeruginosa, which grew at rates comparable to the untreated controls. Incomplete biocidal activity was seen in Enterobacter cloacae at the 0.3% level on the third day, but enough organism remained viable for culture and identification.

Polypropylene copolymer is a clear, durable, and cost effective material. In addition polypropylene copolymer is more resistant to breakage than polystyrene. Therefore, polypropylene copolymer may be favored over polystyrene in forming the device of the present invention.

The exemplary embodiment of the present invention comprises a test tube formed from injection molding a mixture of plastic and triclosan. In the present invention, primary antimicrobial activity results from the circulation of urine solubles and solutes that have intimate contact with the test tube walls because of the kinetic energy of water at room temperature and the high ratio of surface area on the inside of the tube relative to the fluid volume of the urine. As a result, the present invention can be used to effectively preserve a urine specimen having a volume within a range of about 1 to 8 milliliters due to the fact that there is almost a direct exposure ratio of urine (cubic centimeters volume) to surface area (square centimeters) of the tube. Therefore, unlike prior art containers, the present invention is not limited by the size or amount of the urine sample in order to effectively preserve the urine sample. In addition, the antimicrobial agent used in the present invention, namely triclosan, is extremely hydrophobic which results in less than about 0.019% of the additive in the entire tube leaching into the urine sample from the interior surfaces exposed to liquid contact.

It will be understood that the foregoing description is of preferred exemplary embodiments of the present invention, and that the present invention is not limited to the specific examples and compositions set forth herein. Such examples and compositions are for illustrative purposes only. Various modifications may be made in light thereof as will be suggested to persons skilled in the art without departing from the scope of the invention as expressed in the appended claims.

What is claimed is:

1. A device for maintaining stabilization of a urine specimen at room temperature for urine transport which comprises a plastic molded container that is simultaneously injection molded with both a plastic and a hydrophobic antimicrobial wherein the plastic molded container is configured to limit a ratio of urine volume to be contained in the container to an interior surface of the container to a value less than one and where the container maintains the presence and concentration of diagnostic markers contained within the urine.

2. The device of claim 1 wherein said antimicrobial comprises at least one of triclosan, zinc pyrithione, 3-ido-2-propynyl butyl carbamate, silver compounds and organotin compounds.

3. The device of claim 1 wherein said plastic comprises at least one of a polypropylene copolymer, a polystyrene, a styrene butadiene copolymer, a clarified polypropylene, a polycarbonate, and an acrylic.

4. The device of claim 2 wherein the antimicrobial is within a range of about 0.01 to 0.80% by weight.

5. The device of claim 3 wherein the plastic preferably comprises a polypropylene copolymer or polystyrene within a range of about 99.2 to 99.99% by weight.

6. The device of claim 1 wherein said container comprises at least one of a tube shape, a bottle shape, a cuvette shape, and a vial shape.

7. The device of claim 1 wherein less than about 0.02% of said antimicrobial exposed to the urine specimen is leached into the urine specimen over a time period of 72 hours.

8. The device of claim 1 wherein said device is capable of preserving the urine specimen at room temperature for at least one of storage and transport for urinalysis for up to about 72 hours.

9. The device of claim 1 wherein said antimicrobial is uniformly distributed on both a surface area of said container and throughout a mass of said container.

10. The device of claim 1 wherein said container prevents intrinsic growth of microbes which would alter the composition of the urine specimen.

11. The device of claim 1 wherein said container prevents growth of microbes, without adding solids to the container, which could alter a specific gravity of the urine specimen.

12. The device of claim 1 wherein said container prevents intact cells contained in the urine specimen from being degraded by micro-organisms.

13. A device for maintaining stabilization of a urine specimen at room temperature for culturing at least one of a bacteria and a fungus common to the urinary tract which comprises a plastic injection molded container that is simultaneously injection molded with both a plastic and a hydrophobic antimicrobial wherein the plastic injection molded container is configured to limit a ratio of urine volume to be contained in the container to an interior surface of the container to a value less than one and where the device maintains the presence and concentration of diagnostic markers and intact cells contained within the urine.

14. The device of claim 13 wherein said antimicrobial comprises at least one of triclosan, zinc pyrithione, 3-ido-2-propynyl butyl carbamate, silver compounds and organotin compounds.

15. The device of claim 13 wherein said plastic comprises at least one of a polypropylene copolymer, a polystyrene, a styrene butadiene copolymer, a clarified polypropylene, a polycarbonate, and an acrylic.

16. The device of claim 14 wherein the antimicrobial is within a range of about 0.01 to 0.5% by weight.

17. The device of claim 16 wherein the plastic preferably comprises a polypropylene copolymer or polystyrene within a range of about 99.5 to 99.99% by weight.

18. The device of claim 13 wherein said container comprises at least one of a tube shape, a bottle shape, a cuvette shape, and a vial shape.

19. The device of claim 13 wherein less than about 0.02% of said antimicrobial exposed to the urine specimen is leached into the urine specimen over a time period of 72 hours.

20. The device of claim 13 wherein said device is capable of preserving the urine specimen at room temperature for at least one of storage and transport for culture and identification for up to about 72 hours.

21. The device of claim 13 wherein said antimicrobial is uniformly distributed on both a surface area of said container and throughout a mass of said container.

22. The device of claim 13 wherein said container limits the growth of microbes intrinsic to the urine specimen to prevent their loss due to overgrowth before they can be cultured.

23. A container for preserving a urine test specimen at room temperature comprising:
a plastic within a range of about 99.5 to 99.99% by weight; and
a hydrophobic antimocrobial within a range of about 0.01 to 0.80% by weight, wherein said plastic and said hydrophobic antimicrobial are mixed together either before or during injection molding to form a container in the shape of a test tube such that a concentration of diagnostic markers contained in a urine specimen placed in the test tube remains constant.

24. The container of claim 23 wherein said antimicrobial comprises at least one of triclosan, zinc pyrithione, 3-ido-2-propynyl butyl carbamate, silver compounds and organotin compounds.

25. The container of claim 23 wherein said plastic comprises at least one of a polypropylene copolymer, a polystyrene, a styrene butadiene copolymer, a clarified polypropylene, a polycarbonate, and an acrylic.

26. The container of claim 23 wherein the antimicrobial is within a range of about 0.1 to 0.3% by weight.

27. The container of claim 26 wherein the plastic preferably comprises a polypropylene copolymer or polystyrene within a range of about 99.5 to 99.9% by weight.

28. The container of claim 23 wherein less than about 0.02% of said antimicrobial exposed to the urine specimen is leached into the urine specimen over a time period of 72 hours.

29. The container of claim 23 further comprising a friction fit cap.

30. The container of claim 23 wherein said antimicrobial is uniformly distributed on both a surface area of said container and throughout a mass of said container.

31. The container of claim 23 wherein said container prevents intrinsic growth of microbes which would alter the composition or specific gravity of the urine specimen.

32. A method for making a urine transport and storage container which preserves a urine sample for testing comprising the steps of:
selecting a plastic material;
selecting a hydrophobic antimicrobial material;
blending said antimicrobial material into said plastic material during injection molding to form a container having an interior surface area; and
configuring the container to limit a ratio of a urine volume to be contained within the container to the interior surface area of the container to a value less than one and wherein a concentration of diagnostic markers in a the urine volume sample contained in the container remains constant during transport and storage.

33. The method of claim 33 wherein said step of selecting a plastic material comprises the step of selecting at least one of a polypropylene copolymer, a polystyrene, a styrene butadiene copolymer, a clarified polypropylene, a polycarbonate, and an acrylic.

34. The method of claim 33 wherein said step of selecting an antimicrobial comprises the step of selecting at least one of triclosan, zinc pyrithione, 3-ido-2-propynyl butyl carbamate, silver compounds and organotin compounds.

35. The method of claim 33 wherein said step of injection molding comprises the step of forming container having at least one of a tube shape, a bottle shape, a cuvette shape, and a vial shape.

36. The method of claim 33 wherein said container comprises a polypropylene copolymer within about 99.2 to 99.99% by weight and triclosan within about 0.01 to 0.80% by weight.

37. A method for making a urine transport and storage container for preserving a urine specimen at room temperature for testing comprising the steps of:
mixing a plastic and a hydrophobic antimicrobial to form a mixture; and
injection molding said mixture to form a container having an interior surface area; and
configuring the container to limit a ratio of a urine volume to be contained within the container to the interior surface area of the container to a value less than one and where a concentration of diagnostic markers in the urine volume specimen contained in the container remains constant.

38. The method of claim 38 wherein said step of mixing a plastic and an antimicrobial further comprises the step of selecting a plastic from at least one of a polypropylene copolymer, and a polystyrene, a styrene butadiene copolymer, a clarified polypropylene, a polycarbonate, and an acrylic.

39. The method of claim 38 wherein said step of mixing a plastic and an antimicrobial further compromises the step of selecting an antimicrobial from at least one of triclosan, zinc pyrithione, 3-ido-2-propynyl butyl carbamate, silver compounds and organotin compounds.

40. The method of claim 38 wherein said container comprises a polypropylene copolymer within about 99.92 to 99.99% by weight and triclosan within about 0.01 to 0.80% by weight.

41. A device for maintaining stabilization of a urine specimen at room temperature for urine transport comprising a device having a hydrophobic anitimicrobial uniformly distributed throughout a mass of the device wherein the antimicrobial uniformity enables stabilization of a concentration of diagnostic markers contained in urine specimens having a volume within a range of about 1 milliliter to about 8 milliliters that are contained within the device.
